(19) United States
(12) Patent Application Publication
(10) Pub. No.: US 2020/0013025 A1
(43) Pub. Date: Jan. 9, 2020

(54) CONDITIONAL DEFERRED TRANSACTIONS FOR BLOCKCHAIN

(71) Applicant: International Business Machines Corporation, Armonk, NY (US)

(72) Inventors: Mudit Verma, NEW DELHI (IN); Seep Goel, New Delhi (IN); Abhishek Singh, New Delhi (IN); Praveen Jayachandran, Bangalore (IN)

(21) Appl. No.: 16/029,195

(22) Filed: Jul. 6, 2018

(51) Int. Cl. G06Q 20/06; H04L 9/06

(52) U.S. Cl. CPC G06Q 20/06; G06Q 2220/00; H04L 9/0637

(57) ABSTRACT

An example operation may include one or more of creating a deferred blockchain transaction and monitoring the condition until the condition is satisfied. In response to satisfying the condition, the example operation may include one or more of endorsing the deferred blockchain transaction, submitting the deferred blockchain transaction to a transaction queue, and committing blockchain transactions in the transaction queue to a blockchain. The deferred blockchain transaction includes an action and a condition, the action to be executed only after satisfying the condition.

### TECHNICAL FIELD

This application generally relates to transaction processing in permissioned blockchain network, and more particularly, to conditional deferred transactions for blockchains.

### BACKGROUND

A ledger is commonly defined as an account book of entry, in which transactions are recorded. A distributed ledger is ledger that is replicated in whole or in part to multiple computers. A Cryptographic Distributed Ledger (CDL) can have at least some of these properties: irreversibility (once a transaction is recorded, it cannot be reversed), accessibility (any party can access the CDL in whole or in part), chronological and time-stamped (all parties know when a transaction was added to the ledger), consensus based (a transaction is added only if it is approved, typically unanimously, by parties on the network), verifiability (all transactions can be cryptographically verified). A blockchain is an example of a CDL. While the description and figures herein are described in terms of a blockchain, the instant application applies equally to any CDL.

A distributed ledger is a continuously growing list of records that typically apply cryptographic techniques such as storing cryptographic hashes relating to other blocks. A blockchain is one common instance of a distributed ledger and may be used as a public ledger to store information. Although, primarily used for financial transactions, a blockchain can store various information related to goods and services (i.e., products, packages, status, etc.). A decentralized scheme provides authority and trust to a decentralized network and enables its nodes to continuously and sequentially record their transactions on a public “block”, creating a unique “chain” referred to as a blockchain. Cryptography, via hash codes, is used to secure an authentication of a transaction source and removes a central intermediary. A blockchain is a distributed database that maintains a continuously-growing list of records in a blockchain blocks, which are secured from tampering and revision due to their immutable properties. Each block contains a timestamp and a link to a previous block. A blockchain can be used to hold, track, transfer and verify information. Since a blockchain is a distributed system, before adding a transaction to a blockchain ledger, all peers need to reach a consensus status.

Conventionally, transactions requiring deferred invocation at some time in the future under specified conditions are limited by the ability to maintain, track, and execute conditional deferred transactions in permissioned blockchain networks. As such, what is needed is enhanced functionality for blockchain nodes to overcome these limitations.

### SUMMARY

One example embodiment may provide a method that includes one or more of creating a deferred blockchain transaction and monitoring the condition until the condition is satisfied. In response to satisfying the condition, the example operation may include one or more of endorsing the deferred blockchain transaction, submitting the deferred blockchain transaction to a transaction queue, and committing blockchain transactions in the transaction queue to a blockchain. The deferred blockchain transaction includes an action and a condition, the action to be executed only after satisfying the condition.

Another example embodiment may provide a permissioned blockchain network that includes one or more of a client node, one or more endorser nodes, and one or more orderer nodes.

The client node is configured to create a deferred blockchain transaction and request first endorsement of the deferred blockchain transaction. The deferred blockchain transaction includes an action and a condition. The one or more endorser nodes are configured to first and second endorse the deferred blockchain transaction. The one or more orderer nodes are each configured to one or more of receive and store the deferred blockchain transaction and monitor the condition until the condition is satisfied. In response to the condition is satisfied, the one or more orderer nodes are each configured to one or more of request second endorsement of the deferred blockchain transaction, submit the deferred blockchain transaction to a transaction queue, and commit blockchain transactions in the transaction queue to a blockchain.

A further example embodiment may provide a non-transitory computer readable medium comprising instructions, that when read by a processor, cause the processor to perform one or more of creating a deferred blockchain transaction and monitoring the condition until the condition is satisfied. In response to satisfying the condition, the processor is further configured to perform one or more of endorsing the deferred blockchain transaction, submitting the deferred blockchain transaction to a transaction queue, and committing blockchain transactions in the transaction queue to a blockchain. The deferred blockchain transaction comprises an action and a condition, the action to be executed only after satisfying the condition.

### BRIEF DESCRIPTION OF THE DRAWINGS

FIG. 1A illustrates a network diagram of conditional deferred transactions with a blockchain, according to example embodiments.

FIG. 1B illustrates a network diagram of deferred transaction functionality of orderer nodes in a blockchain, according to example embodiments.

FIG. 2A illustrates an example peer node blockchain architecture configuration for an asset sharing scenario, according to example embodiments.

FIG. 2B illustrates an example peer node blockchain configuration, according to example embodiments.

FIG. 3 is a diagram illustrating a permissioned blockchain network, according to example embodiments.

FIG. 4 illustrates a system messaging diagram for performing conditional deferred transactions, according to example embodiments.

FIG. 5A illustrates a flow diagram of an example method of processing conditional deferred transactions in a blockchain, according to example embodiments.

FIG. 5B illustrates a flow diagram of an example method of deferring out of order transactions in a blockchain, according to example embodiments.

FIG. 6A illustrates an example physical infrastructure configured to perform various operations on the blockchain in accordance with one or more operations described herein, according to example embodiments.

FIG. 6B illustrates an example smart contract configuration among contracting parties and a mediating server configured to enforce smart contract terms on a blockchain, according to example embodiments.

FIG. 7 illustrates an example computer system configured to support one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments provide methods, systems, non-transitory computer readable media, devices, and/or networks, which provide conditional deferred transactions for permissioned blockchain networks.

A blockchain is a distributed system, which includes multiple nodes that communicate with each other. A blockchain operates programs called chaincode (e.g., smart contracts, etc.), holds state and ledger data, and executes transactions. Some transactions are operations invoked on the chaincode. In general, blockchain transactions typically must be “endorsed” by certain blockchain members and only endorsed transactions may be committed to the blockchain and have an effect on the state of the blockchain. Other transactions which are not endorsed, are disregarded. There may exist one or more special chaincodes for management functions and parameters, collectively called system chaincodes.

Nodes are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node). Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain.

A ledger is a sequenced, tamper-resistant record of all state transitions of a blockchain. State transitions may result from chaincode invocations (i.e., transactions) submitted by participating parties (e.g., client nodes, ordering nodes, endorser nodes, peer nodes, etc.). A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database, which maintains a current state of the blockchain. There is typically one ledger per channel. Each peer node maintains a copy of the ledger for each channel of which they are a member.

A chain is a transaction log which is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Because the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

The example embodiments are directed to methods, devices, networks, non-transitory computer readable media and/or systems, which support a blockchain solution that includes deferred transaction execution based on when a specific condition is satisfied. Previously, transactions submitted to blockchains are executed immediately (or as soon as possible, based on other simultaneously submitted transactions). Some of the benefits of such a solution include greater flexibility for blockchains, by allowing for both immediate and deferred transaction execution. The deferred transactions may be executed under various user-specified conditions.

Blockchain is different from a traditional database in that blockchain is not a central storage but rather a decentralized, immutable, and secure storage, where nodes must share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein. According to various aspects, conditional deferred transaction execution is implemented due to immutability/accountability, decentralized processing, consensus, and endorsement, which are inherent and unique to blockchain. In particular, conditional deferred blockchain transactions are ultimately stored on an immutable shared ledger on permissioned blockchain networks. The present application utilizes new separate independent conditional transaction processing functionality within each orderer or endorser node in order to provide decentralized processing. Each of the orderer or endorser nodes is involved in the consensus processes since a transaction processing condition is verified by all orderers or endorsers in order to determine the validity of execution. Transactions are endorsed at least at two points: when a transaction proposal is received from a client node, and just prior to transaction execution. It is important to check the endorsement in case to make sure the transaction is still valid.

One of the benefits of the example embodiments is an improvement of the functionality of a computing system by triggering a transaction on blockchain based on a certain condition evaluating to true. For instance, being able to close an auction being conducted on a blockchain platform, if no new bids have been placed for a certain period of time. However, in a decentralized system, it is not clear what party would be responsible for determining that no new bids have been placed during a specified timeout duration. Solving this in a decentralized manner is part of the novelty of the present application. This issue does not arise in a traditional database, as the single owner of the database can unilaterally determine the timeout duration has passed and can invoke the closing of the auction.

Through the blockchain solution described herein, a computing system can perform novel functionality by deferring transaction execution until predefined conditions have been met. Conventional computing systems execute transactions immediately, based upon current conditions.

The example embodiments provide numerous benefits over a traditional database. For example, various advantages are achieved by allowing client nodes to specify execution conditions at the same time a deferred transaction is submitted to the blockchain network as a transaction proposal. Traditional databases respond to read/ write/update requests in real time and in the order received, and do not support conditional deferred execution.

Meanwhile, if a traditional database were used to implement the example embodiments, the example embodiments would suffer from unnecessary drawbacks such as immediate execution and a general inability to act upon externally provided conditions for execution. Accordingly, the example embodiments provide for a specific solution to a problem in the arts/field of conditional deferred transactions in permissioned blockchain networks.

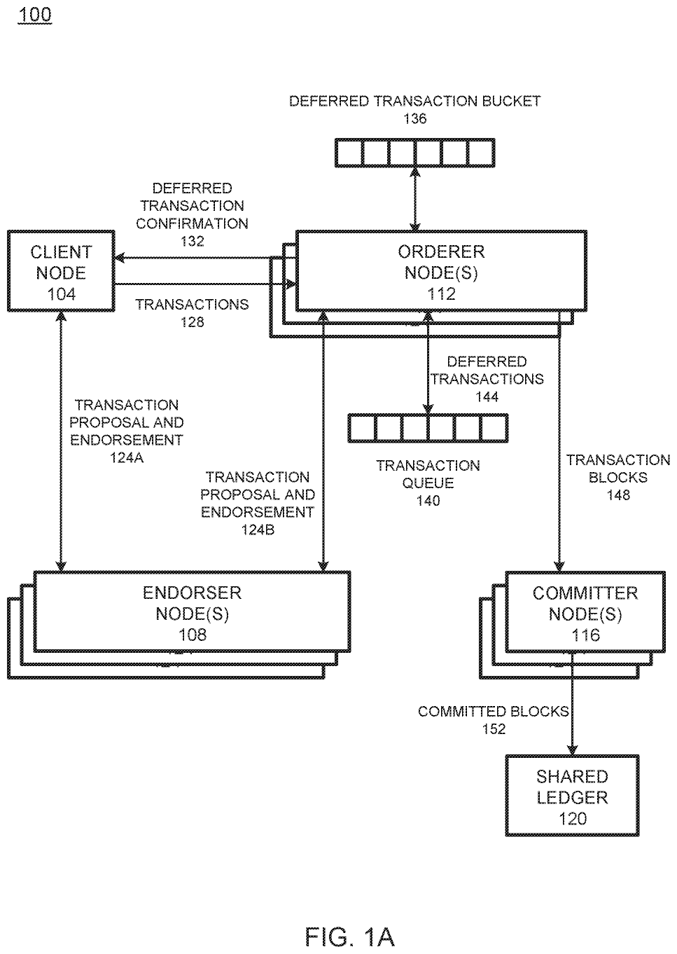

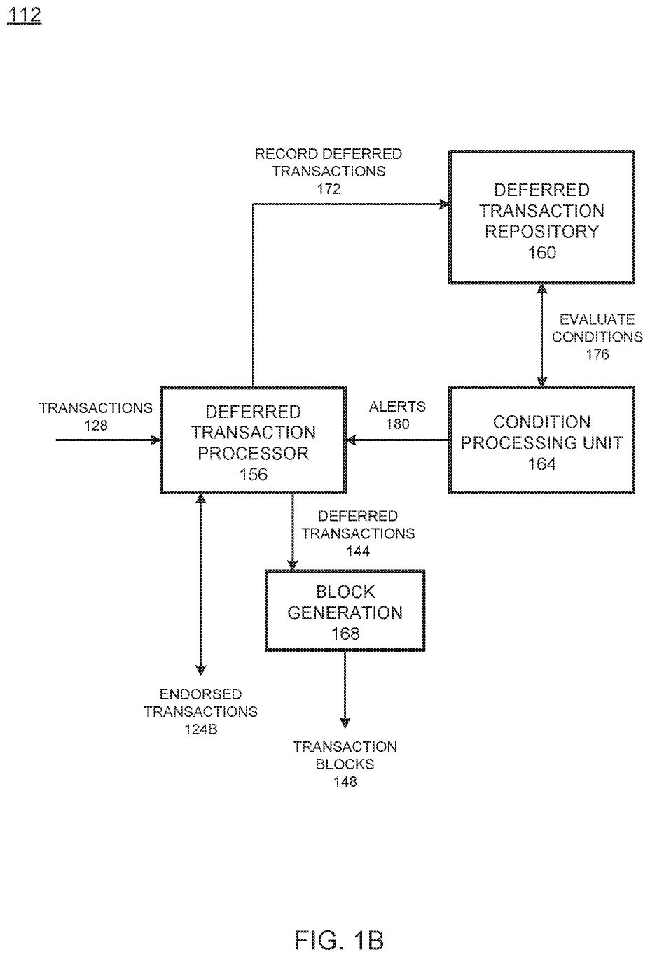

FIG. 1A illustrates a network diagram of conditional deferred transactions with a blockchain according to example embodiments. Referring to FIG. 1A, the network 100 includes one or more client nodes 104. Client nodes 104 initiate transaction proposals 124 to a blockchain network 100, including conditional deferred transaction proposals of the present application. The deferred transaction proposals include one or more conditions and one or more actions to take when the condition is satisfied. The client nodes 104 may generate transaction proposals 124 on their own, or else submit transaction proposals 124 to the blockchain network on behalf of other clients not part of the blockchain network 100. The network 100 itself is a permissioned blockchain network, such as a Hyperledger Fabric network 100.

The present application preferably requires a permissioned blockchain system 100 that supports a common “world-view” state representation (e.g., transactions committed and block height as a notion of time), the ability for a client to specify conditions that involve the world-view as well as smart contract state, at the time of initiating a transaction, the ability to continuously/periodically/at each block, track when conditions become true for each active deferred transaction, the ability to trigger execution of a deferred transaction when its condition becomes true, obtain consensus, and commit the result in a block, and support exactly-once semantics for deferred transaction execution even in the presence of node failures and/or malicious behavior. When the condition evaluates to true, this is confirmed by all the non-faulty blockchain nodes. The deferred blockchain transaction is then invoked. If every blockchain node that determines the condition as true invokes the smart contract, then the transaction would be executed several times, which would be an error. The deferred blockchain transaction must be executed exactly once. For example, one use case for deferred blockchain transactions is to set up recurring payments. On the 1^{st} of every month, a renter would like to send $1000 to a landlord. So, the condition would be “is date 1^{st} of month?” and the corresponding deferred blockchain transaction would be “send $1000 to landlord's account from account x”. The transaction must be executed only when the condition becomes true and must be executed exactly once. The transaction should be executed in a decentralized manner without any one node being responsible for it. If a blockchain network has 10 nodes, when it becomes the 1^{st} of the month each of these nodes would determine the condition to be true. Each of the 10 nodes should not invoke the transaction—this would cause 10 transactions and 10 payments to be made to the landlord. There must be exactly one transaction invocation from the 10 nodes—the nodes then need to arrive at consensus and trigger the transaction invocation exactly once. Once the transaction is triggered, it would go through the usual process within the blockchain network, including decentralized execution.

Many real-world scenarios exist where transaction execution needs to be deferred. For example, in one embodiment payment may need to be made after a specified time (e.g., start of every month). This may be handled with a trusted time oracle if there is one, but not otherwise. A trusted time oracle can be a human or a computer program that is trusted for the information it provides. As blockchain smart contracts execute in a decentralized manner, to avoid different nodes arriving at different results for the execution of the smart contract (non-determinism), smart contracts typically only operate on data stored within the blockchain. This ensures that all nodes executing the smart contract will all arrive at the same output. If the smart contract needs the notion of time (e.g., is it past 9 am US EST on Jun. 1, 2018?), it can ask a time oracle. The time oracle can be trusted to reply the same answer (yes or no) to every node executing the smart contract, ensuring deterministic output produced by all nodes. As an example, oracles have been created for Ethereum and Corda blockchain platforms.

In another embodiment, financial security trading may be closed if a security asset (e.g. a stock) is found to be too volatile in a market or too many transactions are made in a short time frame. Trading markets typically have ‘trading curbs’ or ‘circuit breakers’ as a regulatory instrument. If prices fluctuate rapidly, i.e., rises or drops too fast, the particular stock or the entire stock market could be closed for trading to prevent market crashes. The present application provides the ability for similar constraints to be placed on trading on a digital asset on a blockchain platform, without the need for a central authority determining that volatility is too high (and risky) and also determining to close the market. Using the methods herein, such constraints or curbs can be implemented in a decentralized manner as deferred transactions with a condition on the volatility measure to determine if and when trading must be closed. In yet another embodiment, an auction may close after a specified time duration for which no bids are received (e.g., no bids received for one day).

In yet another transaction, an interest/tax rate may be determined based on a volume of transactions performed by one participant across multiple smart contracts. This may be handled with a parent-smart contract that tracks transactions made in all other smart contracts within a blockchain network but would be highly inefficient and wouldn't allow the multiple smart contracts to operate in parallel. For example, a frequent and high-volume customer can be provided discounts, or a higher interest rate based on the volume of transactions they are performing. For instance, if cumulative deposits across all transactions in a month exceeds $10 million, apply interest rate of 4% on balance; if cumulative deposits across all transactions in a month exceeds $1 million, apply interest rate of 3.5% on the balance. The discount or interest rate or tax to be applied to the client can be calculated as a deferred transaction based on whether the client performs a threshold number of transactions. If this is not a deferred transaction executed in a decentralized manner as in this application, then some authority or entity needs to be trusted to apply the correct interest or tax or discount. This then loses the decentralization benefits of blockchain technology.

All deferred transactions are triggered when a logical condition becomes true—a conditional deferred transaction—which is not supported in today's blockchain platforms. Within smart contracts, all the conditions may not be able to be specified because the smart contract does know many parameters such as a number of transactions committed (i.e. smart contracts lack an external or “world view”). In one embodiment, the logic could involve information available to the platform and not to any one smart contract.

Many possible types of conditions are possible. For example, some of the conditions that can be enforced by the platform include: execute a transaction only when a certain number of blocks have been added since a particular smart contract was deployed, execute a transaction when a certain number of transactions have been performed on a smart contract, execute a transaction when no other transactions (by a participant or set of participants) has been performed for a period of time, execute a transaction when a certain number of transactions have been performed by one participant on one smart contract, execute a transaction when a certain number of transactions have been by a participant across multiple smart contracts, or execute a transaction when a time bound condition is met. In one embodiment, conditions are stored in header portions of deferred blockchain transactions and actions are stored in the payload portions.

The network 100 includes one or more endorser nodes 108, which receive transaction proposals 124. Client nodes 104 send the transaction proposal 124A to each of a required set of peers (endorser nodes 108). Each peer 108 then independently executes a chaincode using the transaction proposal 124A to generate a transaction proposal response 124A. It does not apply this update to the shared ledger (not shown), but rather the peer 108 signs it and returns to the client node 104. An endorser node 108 endorses a proposal response 124A by adding its digital signature, and signing the entire payload using its private key. This endorsement can be subsequently used to prove that this organization's peer 108 generated a particular response. Once the client node 104 has received a sufficient number of signed proposal responses 124A, the conditional deferred transaction is ready to be submitted.

Next, the client node 104 submits the deferred blockchain transaction 128 to one or more endorser nodes 112 in the permissioned blockchain network 100. Normally (i.e. for non-deferred transactions), the orderer nodes 112 receive transactions containing endorsed transaction proposal responses from client nodes 104, orders each transaction relative to other transactions, and packages batches of transactions into blocks ready for distribution back to all peers connected to the orderer nodes 112, including the original endorser nodes 108. However, since the transactions 128 in this case are deferred transactions, they are not to be immediately executed but instead are executed only after one or more conditions specified in the deferred blockchain transaction 128 are satisfied. FIG. 1B describes various details with respect to the endorser nodes 112 to handle conditional deferred transaction processing.

Upon receiving a conditional deferred blockchain transaction 128, each orderer node 112 stores the deferred blockchain transaction 128 to a deferred transaction repository 160 and also to a deferred transaction bucket 136. The orderer nodes 112 announces the deferred blockchain transaction to the other orderer nodes 112 by placing this transaction in the shared transaction bucket 136 and is also recorded on the blockchain for auditing. Each orderer node 112 also provides a deferred transaction confirmation 132 back to the requesting client node 104.

Once the deferred blockchain transaction 128 has been stored, each orderer node 112 monitors the condition specified in the deferred blockchain transaction 128 to determine when the condition has been satisfied. In one embodiment, the condition may include one or more of a time parameter, a blockchain height, a number of blocks, a transaction count, a smart contract state, and a world state for the blockchain. If an orderer node 112 detects the conditions for the deferred blockchain transaction 128 have been met or satisfied, the orderer node 112 generates a transaction proposal for endorsement 124B to the endorser nodes 108. In turn, the endorser nodes 108 simulate the deferred blockchain transaction, calculate the read-write sets, sign the proposal, endorse the deferred blockchain transaction 124B, and send it back to the orderer nodes 112.

Although the transaction proposal 124A from the client node 104 has already been endorsed by this time, it is important to perform this later endorsement to make sure the transaction 128 is still valid. If the transaction 128 is still valid, the endorser nodes 108 provide an endorsement back to the orderer nodes 112. Note that it is possible that more than one orderer node 112 can try to initiate/execute the deferred blockchain transaction, but due to replay-attack protection at the endorser nodes 108, the deferred blockchain transaction will be considered only once. It is also possible that the client node 104 may submit the same deferred blockchain transaction more than once. However, this situation is exactly similar to the situation where more than one orderer node 112 initiates the deferred blockchain transaction and can be handled in the same manner.

Once the transaction has been endorsed 124B and the orderer nodes 112 receive a sufficient number of endorsements, the orderer nodes 112 place the deferred blockchain transaction 144 into a transaction queue 140, where deferred blockchain transactions 144 are buffered until a predetermined number of deferred transactions 144 are ready to be submitted to a new block. The orderer nodes 112 order the transactions 144 properly in the new block, and provide transaction blocks 148 to one or more committer nodes 116. The committer nodes 116 then provide committed blocks 152 to the shared ledger 120, which completes the deferred blockchain transaction.

FIG. 1B illustrates a network diagram of deferred transaction functionality of orderer nodes 112 in a blockchain according to example embodiments. Referring to FIG. 1B, the orderer nodes 112 include new functionality in order to process conditional deferred blockchain transaction 128.

Orderer nodes 112 include a deferred action processor 156, which receives deferred blockchain transaction 128 from client nodes 104, and records the deferred transactions 172 to a deferred transaction repository 160. In one embodiment, the deferred transaction repository 160 is a single data structure including all uncommitted deferred blockchain transaction 128, regardless of conditions or actions to be taken. In another embodiment, the deferred transaction repository 160 is organized into several lists based on condition type. A condition type is any type of sub-category of “conditions” and may include waiting for a time to elapse or occur, a certain block height in the blockchain to be achieved, a certain world state for the blockchain to occur, a certain smart contract state to be achieved, or any other circumstances that are measurable by the orderer nodes 112. These conditions may be present either alone or in combination, such as “a block height of 249”, “a time following Jan. 1, 2028 at 10:00 EST”, “a transaction count=100 in a specific smart contract”, or “a world state of x following a certain time and blockchain height”. In one embodiment, the condition lists are unsorted and conditions for a newly received deferred blockchain transaction are appended to the end of a list. In another embodiment, a list may be internally sorted by parameter value. For example, for a list based on a date for transaction execution, the list may be sorted by date. This may speed up searching and minimize the number of list entries that must be read and evaluated.

An incoming deferred blockchain transaction 128 is placed into the list corresponding to the condition type it has. In one embodiment, if there is not a list corresponding to the condition type of a deferred blockchain transaction 128, the deferred blockchain transaction 128 is placed into a “miscellaneous” list. In another embodiment, if there is not a list corresponding to the condition type of a deferred blockchain transaction 128, a new list is created for a new condition type and the deferred blockchain transaction 128 is placed into a new category type list. The embodiments that utilize multiple category type lists advantageously may be searched faster than one large single list, which results in faster monitoring and condition satisfaction determination for the present application.

A condition processing unit 164 associated with each of the orderer nodes 112 evaluates the conditions for all deferred blockchain transaction sin the deferred transaction repository 160. The evaluation may be continuous, periodically based on time, or periodically based on block height (i.e. the number of committed blocks in the blockchain). When a condition for a specific deferred blockchain transaction has been satisfied, one or more actions corresponding to the satisfied conditions (and included within the payload of the deferred blockchain transaction) are triggered for execution. The condition processing unit 164 provides an alert to the deferred transaction processor 156, which causes the deferred transaction processor 156 to perform final endorsement for the deferred blockchain transaction 128.

The condition processing unit 164 includes logic that processes the conditions associated with transactions and outputs either True or False. For example, “True” may designate transaction that can be immediately executed and “False” may designate transactions that need to be maintained on hold. In one embodiment, the condition processing unit 164 can go through all the transactions in a round-robin fashion and check the condition for all transactions and raise alerts for the transactions for which the condition is true. In another embodiment, the condition processing unit 164 may have separate sub-units for each type of condition. Such similar conditions may require similar logic to be executed in order to send an alert. Logic to process different conditions can be input externally by administrators or may be based on some predefined policy.

The deferred transaction processor 156 sends the deferred blockchain transaction to the endorser nodes 108, which return endorsed transactions 124B. Once a correct number of endorsed transactions 124B have been received from a required subset of endorser nodes 108, the deferred blockchain transaction 144 is placed on the transaction queue 140 to await ordering and formation of a new transaction block 148, as previously discussed.

Although block generation 168 produces transaction blocks 148 for all transactions, whether deferred or not, for the process flow of deferred blockchain transactions 128, the block generation logic 168 converts deferred transactions 144 into transaction blocks 148. When a deferred blockchain transaction is processed by the block generator 168, it is reconfirmed/revalidated for execution by invoking the condition processing unit 164 once again. This is done to ensure that orderer nodes 112 form a consensus on the right execution time for a transaction. This subverts the cases where a malicious/faulty/byzantine orderer node 112 may invoke a deferred transaction for execution even though the conditions have not been met.

In an alternative embodiment, the deferred transaction processor 156, deferred transaction repository 160, and condition processing unit 164 may be provided within the endorser nodes 108 instead of the orderer nodes 112. While this would be similar to a client delegating authority to a bank to initiate a deferred transaction on their behalf, it has the disadvantage that if only one node is entrusted with the condition storage/tracking/resolution responsibility, it could fail. If multiple nodes are entrusted with the condition storage/tracking/resolution responsibility, another round of consensus is needed to ensure exactly once semantics are the result.

The present application describes methods and systems for client nodes 104 to submit deferred blockchain transactions to be executed when one or more specific conditions are satisfied. The conditions may be based both on the smart contract state as well as a world-view of the blockchain platform, and also may be based on one parameter or can be a complex condition involving multiple parameters. The conditions may rely on the consent/information from more than one node in the system, such as a current time. The deferred blockchain transaction is automatically initiated for execution, upon the condition(s) becoming true and the transaction results are included exactly once in the blockchain. In one embodiment, the orderer nodes 112 enforce the conditions associated with conditional transactions and also instantiate execution of the transaction. As such, the conditions and their execution at a deferred time can be auditable with the logs available at different nodes of the system and in the shared ledger.

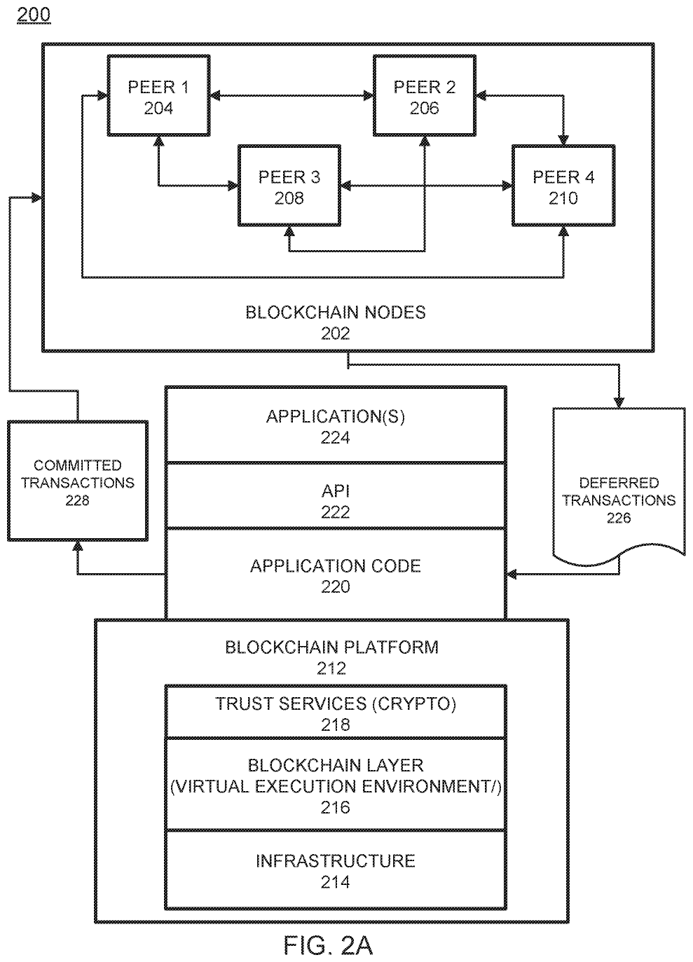

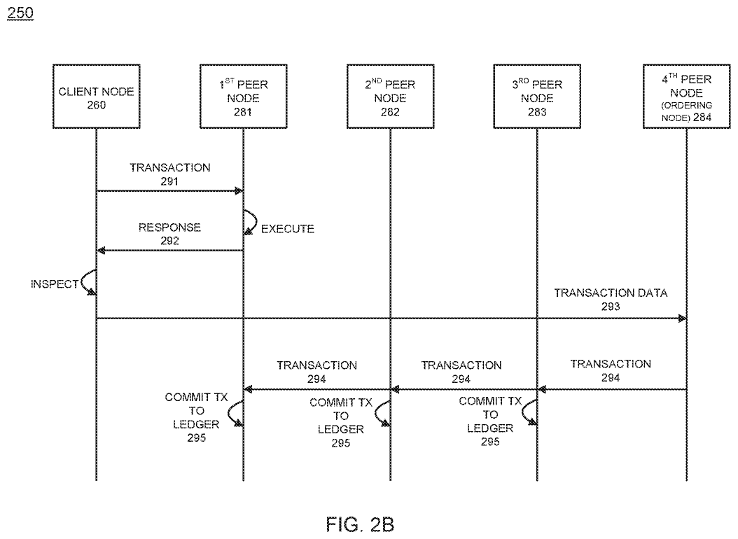

FIG. 2A illustrates a blockchain architecture configuration 200, according to example embodiments. Referring to FIG. 2A, the blockchain architecture 200 may include certain blockchain elements, for example, a group of blockchain nodes 202. The blockchain nodes 202 may include one or more nodes 204-210 (these nodes are depicted by example only). These nodes participate in a number of activities, such as blockchain transaction addition and validation process (consensus). One or more of the blockchain nodes 204-210 may endorse transactions and may provide an ordering service for all blockchain nodes in the architecture 200. A blockchain node may initiate a blockchain authentication and seek to write to a blockchain immutable ledger stored in blockchain layer 216, a copy of which may also be stored on the underpinning physical infrastructure 214. The blockchain configuration may include one or applications 224 which are linked to application programming interfaces (APIs) 222 to access and execute stored program/application code 220 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 204-210.

The blockchain base or platform 212 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 2A may process and execute program/application code 220 via one or more interfaces exposed, and services provided, by blockchain platform 212. The code 220 may control blockchain assets. For example, the code 220 can store and transfer data, and may be executed by nodes 204-210 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, conditional deferred transactions 226 including execution conditions and one or more actions ties to those conditions may be processed by one or more processing entities (e.g., virtual machines) included in the blockchain layer 216. The committed transactions 228 may include one or more conditional deferred blockchain transactions. The physical infrastructure 214 may be utilized to retrieve any of the data or information described herein.

Within chaincode, a smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details. In FIG. 2A, conditions in the deferred transaction repository are monitored. One function may be to submit deferred blockchain transactions having satisfied conditions to one or more endorser nodes 108, which may be provided to one or more of the nodes 204-210.

FIG. 2B illustrates an example of a transactional flow 250 between nodes of the blockchain in accordance with an example embodiment. Referring to FIG. 2B, the transaction flow may include a transaction proposal 291 sent by an application client node 260 to an endorsing peer node 281. The endorsing peer 281 may verify the client signature and execute a chaincode function to initiate the transaction. The output may include the chaincode results, a set of key/value versions that were read in the chaincode (read set), and the set of keys/values that were written in chaincode (write set). The proposal response 292 is sent back to the client 260 along with an endorsement signature, if approved. The client 260 assembles the endorsements into a transaction payload 293 and broadcasts it to an ordering service node 284. The ordering service node 284 then delivers ordered transactions as blocks to all peers 281-283 on a channel. Before committal to the blockchain, each peer 281-283 may validate the transaction. For example, the peers may check the endorsement policy to ensure that the correct allotment of the specified peers have signed the results and authenticated the signatures against the transaction payload 293.

Referring again to FIG. 2B, the client node 260 initiates the transaction 291 by constructing and sending a request to the peer node 281, which is an endorser. The client 260 may include an application leveraging a supported software development kit (SDK), such as NODE, JAVA, PYTHON, and the like, which utilizes an available API to generate a transaction proposal. The proposal is a request to invoke a chaincode function so that data can be read and/or written to the ledger (i.e., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 281 may verify (a) that the transaction proposal is well formed, (b) the transaction has not been submitted already in the past (replay-attack protection), (c) the signature is valid, and (d) that the submitter (client 260, in the example) is properly authorized to perform the proposed operation on that channel. The endorsing peer node 281 may take the transaction proposal inputs as arguments to the invoked chaincode function. The chaincode is then executed against a current state database to produce transaction results including a response value, read set, and write set. However, no updates are made to the ledger at this point. In 292, the set of values, along with the endorsing peer node's 281 signature is passed back as a proposal response 292 to the SDK of the client 260, which parses the payload for the application to consume.

In response, the application of the client 260 inspects/verifies the endorsing peers signatures and compares the proposal responses to determine if the proposal response is the same. If the chaincode only queried the ledger, the application would inspect the query response and would typically not submit the transaction to the ordering node service 284. If the client application intends to submit the transaction to the ordering node service 284 to update the ledger, the application determines if the specified endorsement policy has been fulfilled before submitting (i.e., did all peer nodes necessary for the transaction endorse the transaction). Here, the client may include only one of multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After successful inspection, in step 293 the client 260 assembles endorsements into a transaction and broadcasts the transaction proposal and response within a transaction message to the ordering node 284. The transaction may contain the read/write sets, the endorsing peers signatures and a channel ID. The ordering node 284 does not need to inspect the entire content of a transaction in order to perform its operation, instead the ordering node 284 may simply receive transactions from all channels in the network, order them chronologically by channel, and create blocks of transactions per channel.

The blocks of the transaction are delivered from the ordering node 284 to all peer nodes 281-283 on the channel. The transactions 294 within the block are validated to ensure any endorsement policy is fulfilled and to ensure that there have been no changes to ledger state for read set variables since the read set was generated by the transaction execution. Transactions in the block are tagged as being valid or invalid. Furthermore, in step 295 each peer node 281-283 appends the block to the channel's chain, and for each valid transaction the write sets are committed to current state database. An event is emitted, to notify the client application that the transaction (invocation) has been immutably appended to the chain, as well as to notify whether the transaction was validated or invalidated.

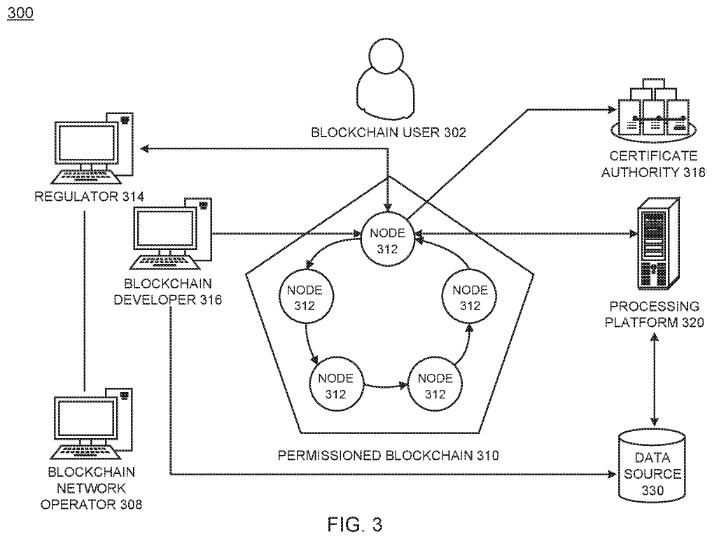

FIG. 3 illustrates an example of a permissioned blockchain network 300, which features a distributed, decentralized peer-to-peer architecture, and a certificate authority 318 managing user roles and permissions. In this example, the blockchain user 302 may submit a transaction to the permissioned blockchain network 310. In this example, the transaction can be a deploy, invoke or query, and may be issued through a client-side application leveraging an SDK, directly through a REST API, or the like. Trusted business networks may provide access to regulator systems 314, such as auditors (the Securities and Exchange Commission in a U.S. equities market, for example). Meanwhile, a blockchain network operator system of nodes 308 manage member permissions, such as enrolling the regulator system 310 as an “auditor” and the blockchain user 302 as a “client.” An auditor could be restricted only to querying the ledger whereas a client could be authorized to deploy, invoke, and query certain types of chaincode.

A blockchain developer system 316 writes chaincode and client-side applications. The blockchain developer system 316 can deploy chaincode directly to the network through a REST interface. To include credentials from a traditional data source 330 in chaincode, the developer system 316 could use an out-of-band connection to access the data. In this example, the blockchain user 302 connects to the network through a peer node 312. Before proceeding with any transactions, the peer node 312 retrieves the user's enrollment and transaction certificates from the certificate authority 318. In some cases, blockchain users must possess these digital certificates in order to transact on the permissioned blockchain network 310. Meanwhile, a user attempting to drive chaincode may be required to verify their credentials on the traditional data source 330. To confirm the user's authorization, chaincode can use an out-of-band connection to this data through a traditional processing platform 320.

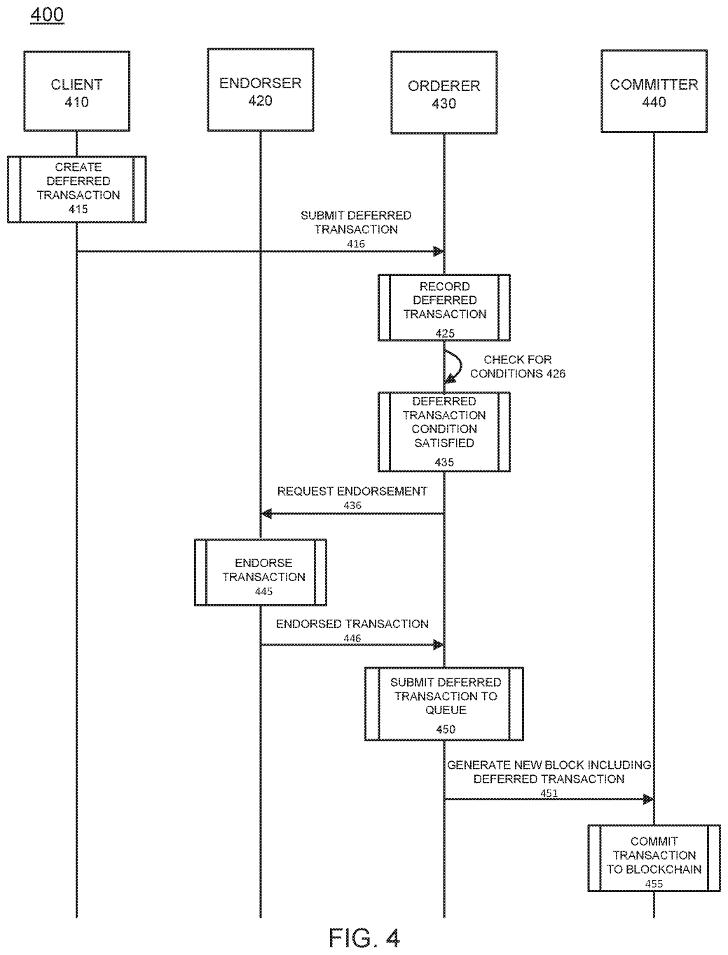

FIG. 4 illustrates a system messaging diagram for performing conditional deferred transactions according to example embodiments. Referring to FIG. 4, the system diagram 400 includes a client node 410, an endorser node 420, an orderer node 430, and a committer node 440. Each of these nodes is part of a permissioned blockchain network configured to process conventional (i.e. immediate) blockchain transactions as well as conditional deferred blockchain transactions.

The client node 410 creates a deferred transaction 415. The deferred transaction includes a condition to process the deferred transaction and is initially endorsed by one or more endorser nodes 420 as a deferred transaction proposal. Once the deferred transaction proposal has been approved by the endorser nodes 420, the client node 410 submits the deferred transaction 416 to one or more orderer nodes 430.

The orderer nodes 430 record the deferred transaction 425 to a deferred transaction repository associated with each orderer node 430. The orderer nodes 430 share the deferred transaction with the other orderer nodes 430 in the blockchain network and also records the deferred transaction in a block within a deferred transaction bucket shared by all orderer nodes 430. A confirmation of receipt of the deferred transaction is also sent to the client node 410.

Each orderer node 430 monitors conditions 426 specified in the deferred transaction and as described herein. At some point, conditions in the deferred transaction may be satisfied 435 or triggered—which then initiates the action specified by the deferred transaction. The orderer nodes 430 request final endorsement 436 of the deferred transaction by the endorser nodes 420. The endorser nodes 420 endorse the deferred transaction 445 and send the endorsed transaction 446 to the orderer nodes 430.

The orderer nodes 430, after having received the endorsed deferred transaction, submit the deferred transaction to a transaction queue 450 that will be used to create a new block of transactions. All orderer nodes 430 verify the satisfied condition for the deferred transaction in order to verify the validity of execution, and generate a new block including the deferred transaction 451 to committer nodes 440. Finally, the committer nodes 440 commit the new block including the deferred transaction to the shared ledger and blockchain 455.

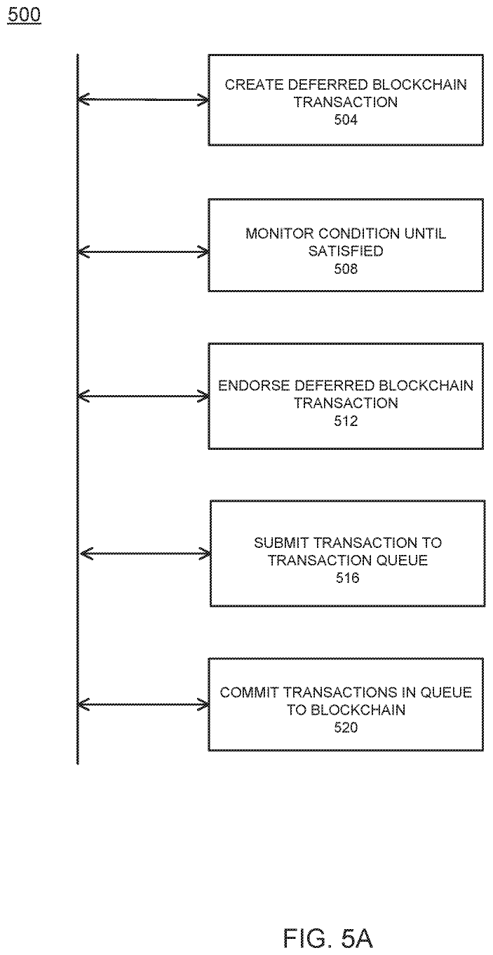

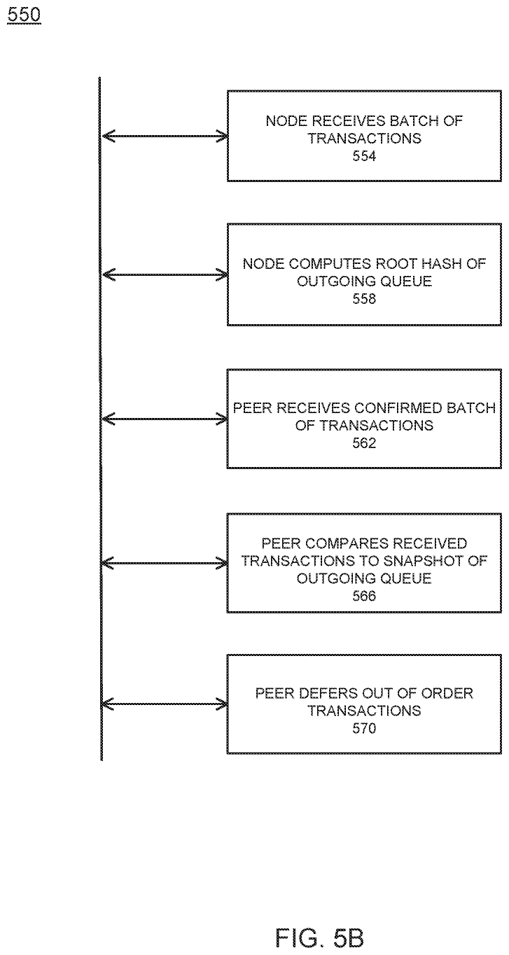

FIG. 5A illustrates a flow diagram of an example method of processing conditional deferred transactions in a blockchain according to example embodiments. Referring to FIG. 5A, the method 500 may include one or more of the following steps.

At block 504, a client node in a permissioned blockchain network creates a deferred blockchain transaction. The deferred blockchain transaction includes one or more conditions and one or more actions.

At block 508, an orderer node receives the deferred blockchain transaction from the client node and stores the deferred blockchain transaction. The orderer node then monitors the one or more conditions until the one or more conditions are satisfied.

At block 512, in response to the one or more conditions are satisfied, the orderer node requests that endorser nodes endorse the deferred blockchain transaction. It is important to endorse the deferred blockchain transaction just prior to executing the transaction to make sure the deferred blockchain transaction is still valid.

At block 516, the orderer node submits the deferred blockchain transaction to a transaction queue. The transaction queue is a buffer for uncommitted deferred blockchain transactions.

At block 520, the orderer node commits transactions in the transaction queue to a blockchain, thus committing the deferred blockchain transaction. A predetermined number of transactions are included in each block.

FIG. 5B illustrates a flow diagram 550 of an example method of deferring out of order transactions in a blockchain, according to example embodiments. Referring to FIG. 5B, the method 550 may also include one or more of the following steps.

At block 554, a node receives a batch of transactions. At any time, for example based on a timer or other event, a node can confirm receipt of a batch of transactions, allowing confirmations to be piggybacked onto messages already sent in a host application.

At block 558, a node computes a root hash of an outgoing queue. The node includes the root hash of a Merkle tree representing its outgoing queue. If the node is challenged to prove that a given transaction was included in the outgoing queue as of a certain summary, or even to provide the queue's entire contents, it can prove the accuracy of its response using standard Merkle proof techniques.

At block 562, a peer receives the confirmed batch of transactions. This batching mechanism allows confirmations to lag behind sent messages. To ensure that messages cannot be ignored without eventually being detected, a predetermined number of messages may be outstanding without confirmation before refusing to send additional messages. If a receiving node ignores a message, a sending node essentially shuts down that channel, thereby ensuring detection.

At block 566, a peer compares received transactions to a snapshot of an outgoing queue. A peer can compare the transactions it has sent to a node against such snapshots of the node's outgoing queue o detect if the node “loses” or reorders transactions. The block height and hash included in summaries enable confirmation that transactions are removed only when they are included in a block. If a node is found to have cheated, for example by removing or reordering transactions in the outgoing queue, the summaries and contents can provide proof that the node has violated the rules. If a node is unwilling or unable to respond to a challenge, it can be penalized using built-in mechanisms such as forfeiting tokens or being excluded, as well as external mechanisms such as lawsuits, regulatory penalties, and reputational harm. However, how long a node is required to retain data to facilitate responses to challenges is a policy question.

At block 570, the peer defers out of order transactions. Transactions may be processed in the permutation order, deferring consideration of any transaction that cannot yet be processed because its nonce is out of order. Deferred transactions remain in permutation order. Once all transactions have been considered, the deferred transactions are similarly processed in permutation order, again deferring any transaction that still cannot be processed because its nonce is out of order. This process is repeated until all transactions have been processed, or until a full pass over the deferred transactions yields no more transactions that can be processed. Since there is no way to order the remaining transactions, they can be explicitly rejected.

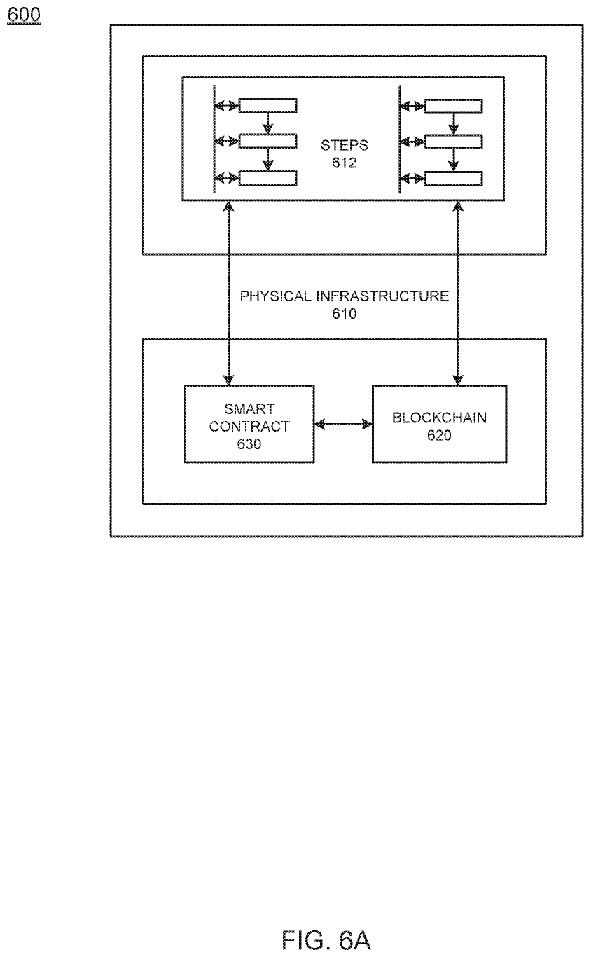

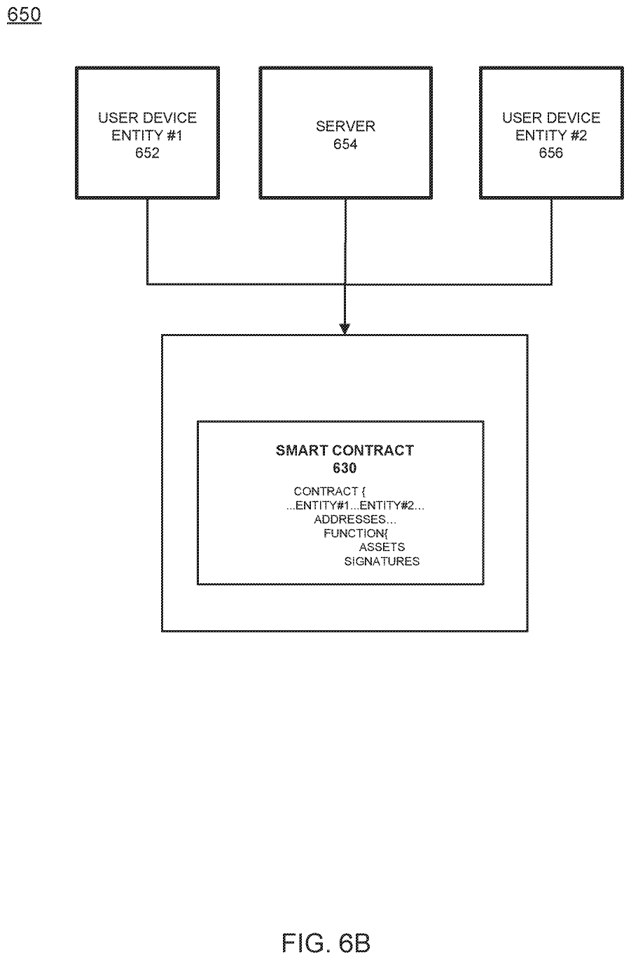

FIG. 6A illustrates an example physical infrastructure configured to perform various operations on the blockchain in accordance with one or more of the example methods of operation according to example embodiments. Referring to FIG. 6A, the example configuration 600 includes a physical infrastructure 610 with a blockchain 620 and a smart contract 630, which may execute any of the operational steps 612 included in any of the example embodiments. The steps/operations 612 may include one or more of the steps described or depicted in one or more flow diagrams and/or logic diagrams. The steps may represent output or written information that is written or read from one or more smart contracts 630 and/or blockchains 620 that reside on the physical infrastructure 610 of a computer system configuration. The data can be output from an executed smart contract 630 and/or blockchain 620. The physical infrastructure 610 may include one or more computers, servers, processors, memories, and/or wireless communication devices.

FIG. 6B illustrates an example smart contract configuration among contracting parties and a mediating server configured to enforce the smart contract terms on the blockchain according to example embodiments. Referring to FIG. 6B, the configuration 650 may represent a communication session, an asset transfer session or a process or procedure that is driven by a smart contract 630 which explicitly identifies one or more user devices 652 and/or 656. The execution, operations and results of the smart contract execution may be managed by a server 654. Content of the smart contract 630 may require digital signatures by one or more of the entities 652 and 656, which are parties to the smart contract transaction. The results of the smart contract execution may be written to a blockchain as a blockchain transaction.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

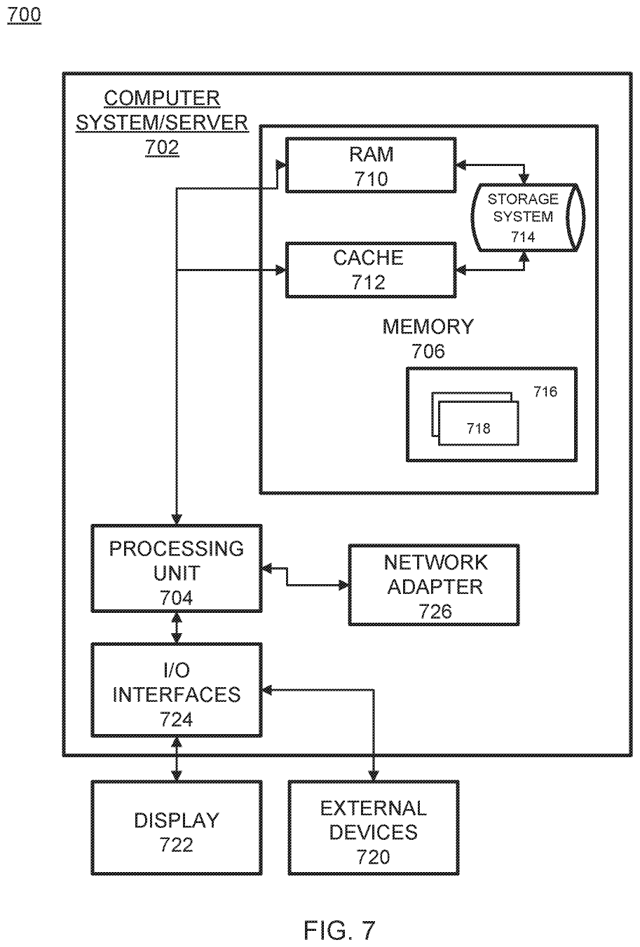

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 7 illustrates an example computer system architecture 700, which may represent or be integrated in any of the above-described components, etc.

FIG. 7 is not intended to suggest any limitation as to the scope of use or functionality of embodiments of the application described herein. Regardless, the computing node 700 is capable of being implemented and/or performing any of the functionality set forth hereinabove.

In computing node 700 there is a computer system/server 702, which is operational with numerous other general purpose or special purpose computing system environments or configurations. Examples of well-known computing systems, environments, and/or configurations that may be suitable for use with computer system/server 702 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 702 may be described in the general context of computer system-executable instructions, such as program modules, being executed by a computer system. Generally, program modules may include routines, programs, objects, components, logic, data structures, and so on that perform particular tasks or implement particular abstract data types.

Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 702 in cloud computing node 700 is shown in the form of a general-purpose computing device. The components of computer system/server 702 may include, but are not limited to, one or more processors or processing units 704, a system memory 706, and a bus that couples various system components including system memory 706 to processor 704.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and non-volatile media, removable and non-removable media. System memory 706, in one embodiment, implements the flow diagrams of the other figures. The system memory 706 can include computer system readable media in the form of volatile memory, such as random-access memory (RAM) 710 and/or cache memory 712. Computer system/server 702 may further include other removable/non-removable, volatile/non-volatile computer system storage media. By way of example only, storage system 714 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 706 may include at least one program product having a set (e.g., at least one) of program modules that are configured to carry out the functions of various embodiments of the application.

Program/utility 716, having a set (at least one) of program modules 718, may be stored in memory 706 by way of example, and not limitation, as well as an operating system, one or more application programs, other program modules, and program data. Each of the operating system, one or more application programs, other program modules, and program data or some combination thereof, may include an implementation of a networking environment. Program modules 718 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 702 may also communicate with one or more external devices 720 such as a keyboard, a pointing device, a display 722, etc.; one or more devices that enable a user to interact with computer system/server 702; and/or any devices (e.g., network card, modem, etc.) that enable computer system/server 702 to communicate with one or more other computing devices. Such communication can occur via I/O interfaces 724. Still yet, computer system/server 702 can communicate with one or more networks such as a local area network (LAN), a general wide area network (WAN), and/or a public network (e.g., the Internet) via network adapter 726. As depicted, network adapter 726 communicates with the other components of computer system/server 702 via a bus. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
creating a deferred blockchain transaction, the deferred blockchain transaction comprising an action and a condition, the action to be executed only after satisfying the condition;
monitoring the condition until the condition is satisfied;
in response to satisfying the condition:
endorsing the deferred blockchain transaction;
submitting the deferred blockchain transaction to a transaction queue; and
committing blockchain transactions in the transaction queue to a blockchain.

2. The method of claim 1, wherein the condition comprising one or more of a time parameter, a blockchain height, a number of blocks, a transaction count, a smart contract state, and a world state for the blockchain.

3. The method of claim 1, further comprising:
executing the action only one time in response to endorsing the deferred blockchain transaction, wherein results of the deferred blockchain transaction being present in the blockchain only one time.

4. The method of claim 1, further comprising:
sharing the deferred blockchain transaction among a plurality of orderer nodes within a blockchain network corresponding to the blockchain; and
checking, by each orderer node of the plurality of orderer nodes, the deferred blockchain transaction for validity.

5. The method of claim 1, wherein in response to creating the deferred blockchain transaction, the method further comprising:
providing a first endorsement for the deferred blockchain transaction in response to creating the deferred blockchain transaction; and
verifying the deferred blockchain transaction has not changed between the first endorsement and the endorsement in response to satisfying the condition.

6. The method of claim 1, wherein monitoring the condition until the condition is satisfied comprising:
assigning the condition to a list storing conditions for all uncommitted deferred blockchain transactions, each condition in the list mapped to a corresponding uncommitted deferred blockchain transaction;
periodically searching the list for satisfied conditions; and
identifying the deferred blockchain transaction when the condition evaluates as true.

7. The method of claim 1, wherein monitoring the condition until the condition is satisfied comprising:
assigning the condition to a list storing conditions for uncommitted deferred blockchain transactions having a same condition type as the deferred blockchain transaction, wherein each condition type having a different corresponding list, wherein each condition in the list being mapped to a corresponding uncommitted deferred blockchain transaction;
periodically searching the list for satisfied conditions; and
identifying the deferred blockchain transaction when the condition evaluates as true.

8. A system, which comprises:
a permissioned blockchain network, which comprises:
a client node, configured to:
create a deferred blockchain transaction, the deferred blockchain transaction comprises an action and a condition; and
request first endorsement of the deferred blockchain transaction;
one or more endorser nodes, configured to first and second endorse the deferred blockchain transaction; and
one or more orderer nodes, each configured to:
receive and store the deferred blockchain transaction;
monitor the condition until the condition is satisfied;
in response to the condition is satisfied:
request second endorsement of the deferred blockchain transaction;
submit the deferred blockchain transaction to a transaction queue; and
commit blockchain transactions in the transaction queue to a blockchain.

9. The system of claim 8, wherein the condition comprises one or more of a time parameter, a blockchain height, a number of blocks, a transaction count, a smart contract state, and a world state for the blockchain.

10. The system of claim 8, wherein a first orderer node that requests second endorsement of the deferred blockchain transaction prior to other endorser nodes of the one or more endorser nodes, are further configured to:
execute the action only one time, wherein results of the deferred blockchain transaction are present in the blockchain only one time.

11. The system of claim 8, wherein the one or more orderer nodes are further configured to:
share the deferred blockchain transaction among other orderer nodes; and
check the deferred blockchain transaction for validity.

12. The system of claim 8, wherein the one or more orderer nodes are further configured to:
verify the deferred blockchain transaction has not changed between the first endorsement and the second endorsement.

13. The system of claim 8, wherein the one or more orderer nodes monitors the condition until the condition is satisfied comprises the one or more orderer nodes each further configured to:
assign the condition to a list that comprises conditions for all uncommitted deferred blockchain transactions, each condition in the list mapped corresponds to an uncommitted deferred blockchain transaction;
search the list for satisfied conditions; and
identify the deferred blockchain transaction when the condition evaluates as true.

14. The system of claim 8, wherein the one or more orderer nodes monitors the condition until the condition is satisfied comprises the one or more orderer nodes each further configured to:
assign the condition to a list that comprises conditions for uncommitted deferred blockchain transactions that have a same condition type as the deferred blockchain transaction, wherein each condition type has a different list, wherein each condition in the list corresponds to an uncommitted deferred blockchain transaction;
search the list for satisfied conditions; and
identify the deferred blockchain transaction when the condition evaluates as true.

15. A non-transitory computer readable medium comprising instructions, that when read by a processor, cause the processor to perform:
creating a deferred blockchain transaction, the deferred blockchain transaction comprising an action and a condition, the action to be executed only after satisfying the condition;
monitoring the condition until the condition is satisfied;
in response to satisfying the condition:
endorsing the deferred blockchain transaction;
submitting the deferred blockchain transaction to a transaction queue; and
committing blockchain transactions in the transaction queue to a blockchain.

16. The non-transitory computer readable medium of claim 15, wherein the condition comprising one or more of a time parameter, a blockchain height, a number of blocks, a transaction count, a smart contract state, and a world state for the blockchain.

17. The non-transitory computer readable medium of claim 15, further comprising:
executing the action only one time in response to endorsing the deferred blockchain transaction, wherein results of the deferred blockchain transaction being present in the blockchain only one time.

18. The non-transitory computer readable medium of claim 15, further comprising:
sharing the deferred blockchain transaction among a plurality of orderer nodes within a blockchain network corresponding to the blockchain; and
checking, by each orderer node of the plurality of orderer nodes, the deferred blockchain transaction for validity.

19. The non-transitory computer readable medium of claim 15, wherein in response to creating the deferred blockchain transaction, the method further comprising:
providing a first endorsement for the deferred blockchain transaction in response to creating the deferred blockchain transaction; and
verifying the deferred blockchain transaction has not changed between the first endorsement and the endorsement in response to satisfying the condition.

20. The non-transitory computer readable medium of claim 15, wherein monitoring the condition comprising one of:
assigning the condition to a list storing conditions for all uncommitted deferred blockchain transactions, each condition in the list mapped to a corresponding uncommitted deferred blockchain transaction;
periodically searching the list for satisfied conditions; and
identifying the deferred blockchain transaction when the condition evaluates as true; or
assigning the condition to a list storing conditions for uncommitted deferred blockchain transactions having a same condition type as the deferred blockchain transaction, wherein each condition type having a different corresponding list, wherein each condition in the list being mapped to a corresponding uncommitted deferred blockchain transaction;
periodically searching the list for satisfied conditions; and
identifying the deferred blockchain transaction when the condition evaluates as true.
